(19) United States
(12) Patent Application Publication
(10) Pub. No.: US 2017/0374563 A1
(43) Pub. Date: Dec. 28, 2017

(54) INTRA SITE INTERFERENCE MITIGATION

(71) Applicant: Nokia Technologies Oy, Espoo (FI)

(72) Inventor: Hannu Ilmari PIRILA, Littoinen (FI)

(21) Appl. No.: 15/539,820

(22) PCT Filed: Feb. 9, 2015
(86) PCT No.: PCT/US15/15027

§ 371 Date: Jun. 26, 2017

(51) Int. Cl. H04W 16/28; H04W 16/04; H04W 16/10; H04W 28/02

(52) U.S. Cl. CPC H04W 16/28; H04W 28/0268; H04W 16/04; H04W 16/10

(57) ABSTRACT

In some example embodiments there is provided a method. The method may include receiving an allocation of an antenna sector and a frequency band, wherein the allocation is selected from a plurality of sectors, wherein adjacent sectors in the plurality of sectors operate at different frequencies and intersect at a midpoint to enable a reduction in interference among the adjacent sectors; and receiving and/or transmitting, in response to the received allocation, on the allocated antenna sector and frequency band. Related systems, methods, and articles of manufacture are also described.

### FIELD

The subject matter described herein relates to interference mitigation.

### BACKGROUND

Wireless devices including base stations and the like may implement sector antennas to provide a directional radiation pattern to a receiver. This directional radiation pattern may provide gain, when compared to an omni-directional antenna. For example, wireless device may include a plurality of sector antennas, each of which serves a given sector of the cell or site associated with the base station. Alternatively or additionally, the wireless device may use beam forming and electronically steer to a given sector. In this way, the base station may provide higher capacity/data rate service to the devices in the sector.

### SUMMARY

In some example embodiments there is provided a method. The method may include receiving an allocation of an antenna sector and a frequency band, wherein the allocation is selected from a plurality of sectors, wherein adjacent sectors in the plurality of sectors operate at different frequencies and intersect at a midpoint to enable a reduction in interference among the adjacent sectors; and receiving and/or transmitting, in response to the received allocation, on the allocated antenna sector and frequency band.

In some variations, one or more of the features disclosed herein including the following features can optionally be included in any feasible combination. The adjacent sectors may include the allocated antenna sector and the allocated frequency band and another antenna sector and another frequency band, wherein the allocated frequency band and the other frequency band may operate at different cellular frequencies, and wherein the allocated antenna sector and the other antenna sector may intersect at the midpoint comprising 30 degrees. The allocated antenna sector and the other antenna sector may be spaced by 60 degrees. A base station may include an antenna array having a sector pattern including the allocated antenna sector and the other antenna sector spaced by 60 degrees from the allocated antenna sector. The sector pattern may include six sectors spaced at 60 degrees between each sector, wherein any of the adjacent sectors operate at different frequencies. The sector pattern may be fixed at a given base station. The at least one channel quality indicator may be sent to a network to enable resource allocation, wherein the at least one channel quality indicator may include a measurement of a channel on the antenna sector and the frequency band. A location of a user equipment may be sent to a network to enable a response including a resource allocation. A base station location may be sent to enable formation of a beam in a direction covering the base station. A user equipment may perform the receiving the allocation, and wherein the user equipment may include a customer premises equipment, wherein the customer premises equipment may include a first interface for interfacing with a cellular network and a second interface for interfacing with at least one other apparatus within a customer premises. The plurality of sectors may include form a sector pattern including 12 sectors spaced by 30 degrees The receiving and/or transmitting may be performed in a carrier aggregation in which first and second carriers from the adjacent sectors are used for the carrier aggregation.

Moreover, in some example embodiments there is provided a method. The method may include receiving, at a base station, information comprising at least one of a channel quality indicator measured by a user equipment or a location of the user equipment; and sending, by the base station, an allocation to the user equipment, wherein the allocation includes an antenna sector and a frequency band, wherein the allocation is based on the received information, wherein the allocation is selected from a plurality of sectors, wherein adjacent sectors in the plurality of sectors operate at different frequencies and intersect at a midpoint to enable a reduction in interference among the adjacent sectors.

In some variations, one or more of the features disclosed herein including the following features can optionally be included in any feasible combination. The base station may transmit and/or receive on the allocated antenna sector and frequency band. The adjacent sectors may include the allocated antenna sector and the allocated frequency band and another antenna sector and another frequency band, wherein the allocated frequency band and the other frequency band may operate at different cellular frequencies, and wherein the allocated antenna sector and the other antenna sector may intersect at the midpoint comprising 30 degrees. The allocated antenna sector and the other antenna sector may be spaced by 60 degrees. The base station may include an antenna array having a sector pattern including the allocated antenna sector and the other antenna sector spaced by 60 degrees. The sector pattern may include six sectors spaced at 60 degrees between each sectors, wherein any of the adjacent sectors operate at different frequencies. The sector pattern may be fixed at a given base station. The allocation may be determined to enable formation of a beam in a direction covering the user equipment.

The above-noted aspects and features may be implemented in systems, apparatuses, methods, and/or computer-readable media depending on the desired configuration. The details of one or more variations of the subject matter described herein are set forth in the accompanying drawings and the description below. Features and advantages of the subject matter described herein will be apparent from the description and drawings, and from the claims. In some exemplary embodiments, one of more variations may be made as well as described in the detailed description below and/or as described in the following features.

### DESCRIPTION OF DRAWINGS

In the drawings,

FIG. 1A depicts an example of a system 100 for intra site interference mitigation based on a certain antenna sector pattern, in accordance with some example embodiments;

FIG. 1B depicts an example where the antenna sector pattern of FIG. 1A is not implemented;

FIG. 2A depicts another example of a system 200 for intra site interference mitigation based on the certain antenna sector pattern, in accordance with some example embodiments;

FIG. 2B depicts a customer premises equipment forming a beam towards a base station, in accordance with some example embodiments;

FIG. 3 depicts an example of a process 300 for assigning the certain antenna sector pattern, in accordance with some example embodiments;

FIG. 4 depicts the system of FIG. 2A after the introduction of another device which may be a trigger for process 300, in accordance with some example embodiments;

FIG. 5 an example of an apparatus, in accordance with some example embodiments.

Like labels are used to refer to the same or similar items in the drawings.

### DETAILED DESCRIPTION

In some wireless systems, there may be a need to minimize the amount of interference between sectors. Specifically, when a client device is in between two sectors (which may have the same or similar signal quality) of the same site served by a wireless access point/base station, the client device may connect to either of the sectors. However, the client device may suffer intra site sector interference from the other sector which was not selected. This interference may be especially severe in systems in which the sectors use the same frequencies (for example, same channels or bands). Moreover, in some high data rate or capacity systems such as Long Term Evolution to the home (LTTH), a client device may need to be able to receive data at very high data rates, so a relatively high signal-to-interference-plus-noise (SINR) ratio may be needed (so the reduction of the adjacent sector interference may enable in part the very high data rates required of LTTH). Although some of the examples refer to LTTH, the subject matter disclosed herein may be used in other wireless systems as well.

In some example embodiments, there is provided a way to reduce the interference between sectors within a given site.

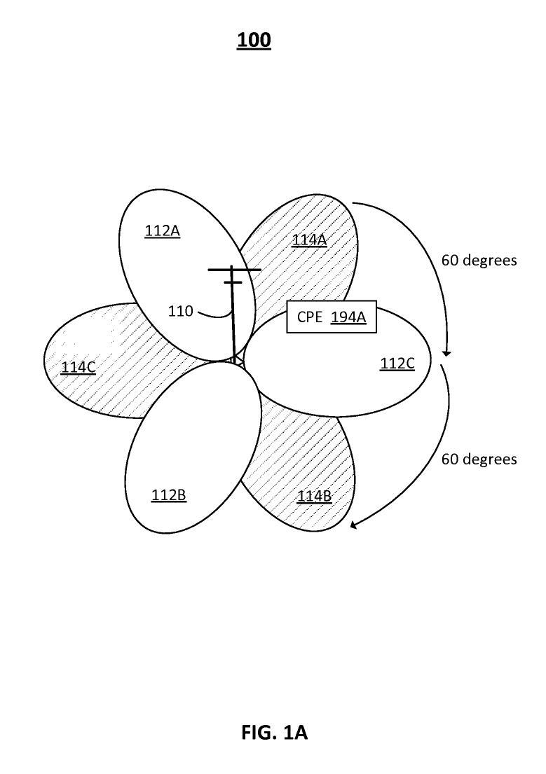

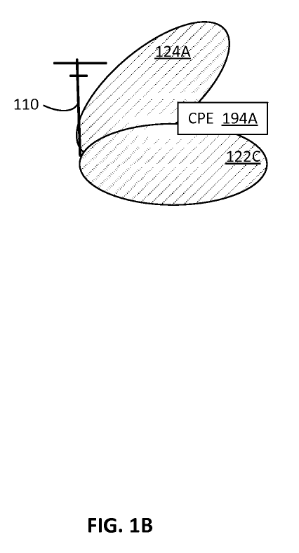

FIG. 1A depicts an example base station 110 including sector antennas configured to have sectors 112A-C/114A-C, in accordance with some example embodiments. In some example embodiments, the base station 110 may include 6 sector antennas, one for each sector, although the sectors may be implemented by other quantity of antennas as well and/or may include beam forming and steering as well. For example, a first sector antenna may have an antenna pattern that corresponds to the radiation pattern or sector, such as sector 114A; a second sector antenna may have a radiation pattern or sector, such as sector 112C; and so forth for each sector antenna.

In some example embodiments, sectors 112A-C/114A-C may be on different frequencies, in accordance with some example embodiments. For example, sectors 114A, 114B, and 114C may be on a first frequency (for example, a channel on the 1.8 GHz band), while sectors 112A, 112B, and 112C may be on second frequency (for example, a channel on the 2.6 GHz band), although the sectors may be assigned to other frequencies and bands as well.

In some example embodiments, sectors 112A-C/114A-C may be configured, so that a given sector has a sector boundary that is at about the middle of an adjacent sector. To illustrate, sector 114A may have a sector boundary that is at about the middle of sector 112C. In the example of FIG. 1A, the beam 112C may be about 60 degrees from beam 114A (as measured from the centers of each beam), while beam 114B may be about 60 degrees from beam 112C, and so forth. In this example, the sector boundary (which is between beam 114A and bean 112C) is at about 30 degrees. In some example embodiments, the sector pattern may be fixed for a given base station. For example, the vacillate deployment the base station may include a fixed sector pattern, such as the 60 degrees between the centers of each sector beam as shown in FIG. 1A. Although some examples refer to 60 degrees between the centers of each sector beam, this angle may vary to a certain degree as well. For example, the centers of each beam can vary by +/1 0.5 degrees, 1 degree, 2 degree, 3 degrees, 4 degrees, 5 degrees, 10 degrees, 12 degrees, 15 degrees, as well as other values (which may depend on the beam width of the sector beam and other factors as well to avoid interference and provide good signal quality between adjacent sectors). To illustrate further, the sector pattern may include 12 sectors each spaced at about 30 degrees, in which case adjacent sectors may be at different frequencies as in the 6 sector example.

In some example embodiments, a network node, such as a resource allocator, may assign resources to a given client device, such as customer premises equipment (CPE) 194A. For example, the resource allocator may assign a given sector such as sector 114A operating on a first frequency or assign sector 112C which is on a second frequency. In this example, base station 110 may select or configure an antenna to transmit on a first frequency on frequency band one and sector 114A. As sectors 114A and 112C are in different frequency bands and have sector boundaries that are at about the middle of an adjacent sector, CPE 194A may operate on sector 114A without receiving interference from adjacent sector 112A (where another CPE may be operating for example).

FIG. 1B depicts CPE 194A between sectors which are not configured as noted above with respect to FIG. 1A. As can be seen in FIG. 1B, the CPE is in between two sectors of relatively similar signal quality. When this is the case, the CPE may select a given sector 124A for example but suffer interference from sector 122C, which is on the same frequency (or a band of frequencies as well).

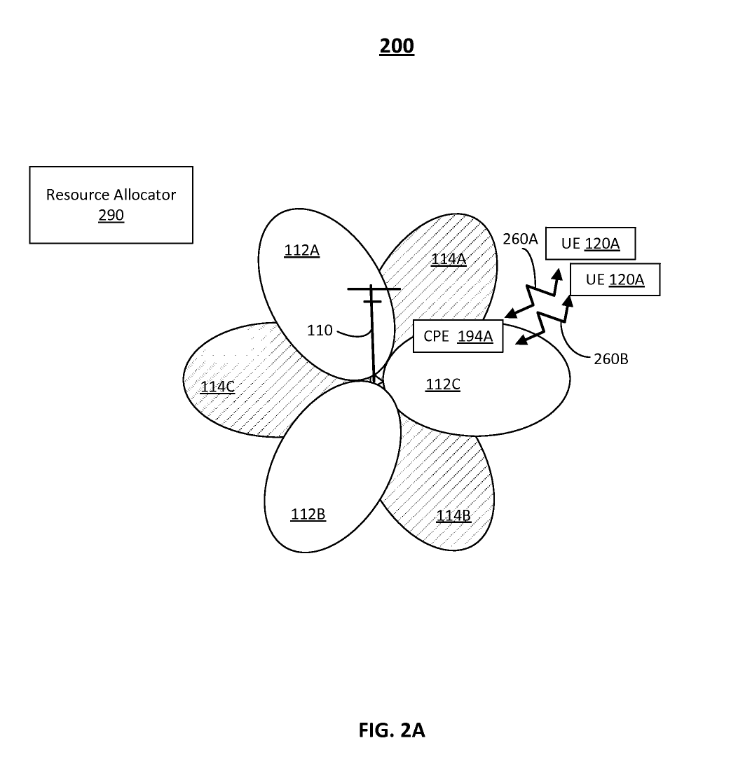

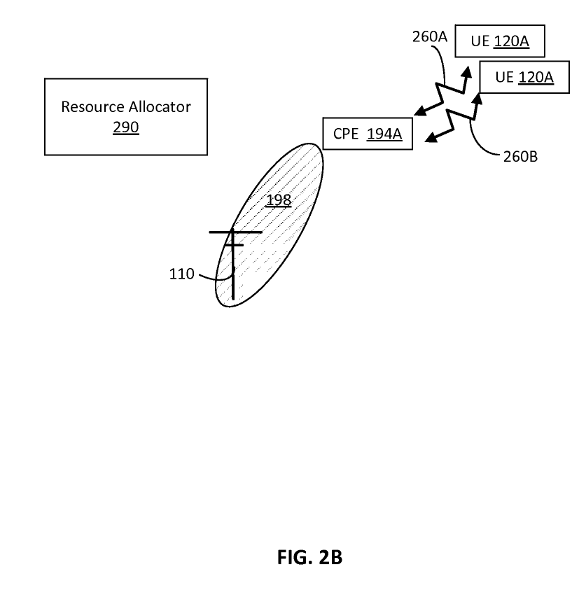

FIG. 2A depicts a system 200, in accordance with some example embodiments. System 200 may include base station 110 including sectors 112A-C and 114A-C and CPE 194A as described above with respect to FIG. 1A.

System 200 further includes a resource allocator 290, in accordance with some example embodiments. Resource allocator 290 may allocate one of the sectors 112A-C and 114A-C to a CPE, as well as assign a frequency for use on the allocated sector.

In the example of FIG. 2A, an example LTTH system is also depicted, in accordance with some example embodiments. In the case of LTTH, CPE 194A may serve as a radio interface to a wireless access network (for example, LTE although other types of radio access technologies may be used as well). This interface may enable reception from the wireless access network on a given sector, such as sector 114A and/or the like for example. Furthermore, CPE 194A may serve as a local interface, such as a router, for other coupled devices at a location or home, such as user equipment (UE) 120A, UE 120B, and/or the like. In the case of LTTH, the base station 110 may include an antenna configured to transmit a downlink at an allocated sector such as sector 114A at a first frequency, to CPE 194A, and this downlink may be at a relatively high data rate/capacity while conserving use of spectrum. For example, a 20 MHz channel in the 1.8 GHz band may require high SINR to provide the high capacity (for example, up to 100 Mbps and exceeding, although other rates may be implemented as well).

Although FIGS. 1A and 2A describe the antenna sectors 112A-C/114A-C being used for downlink transmission from the base station to the CPE 196, the CPE may also use for example electronic beam forming and/or steering to transmit to the base station 110 (although beam forming and steering may be used for example to transmit and/or receive and at the CPE and/or the base station as well). FIG. 2B depicts the system of FIG. 2A and depicts the beam 198 formed by the CPE 194A. Beam 198 have the same or different shape and pattern as sector beam 114A. Resource allocator 290 may allocate to CPE 194A the resources to enable transmission of an uplink via an antenna at CPE 194A having the beam (for example, radiation pattern) 198 (which may be at a band one frequency or another frequency as well). Alternatively or additionally, CPE 194A may receive (via wired and/or wireless connections) the location of the base station 110, which enables the CPE 198A to determine the direction, shape, and the like of beam 198. In some example embodiments, CPE 198A may receive the location of the base station a wireless connection (for example, CPE 198A may operate in an omnidirectional mode at a lower rate during the configuration of the CPE 198A, and once determining the location of the base station 110 enter into a higher data rate mode with beam 198.

Moreover, although FIGS. 1A and 2A-B depict a single base station and CPE, other quantities of base stations and/or CPE may also be implemented as well. Furthermore, although a single site having sectors 112A-C/114A-C is depicted, additional sites including sectors may be deployed as well in accordance with some example embodiments. In addition, although FIG. 2A depicts six sectors, other quantities of sectors may be implemented as well.

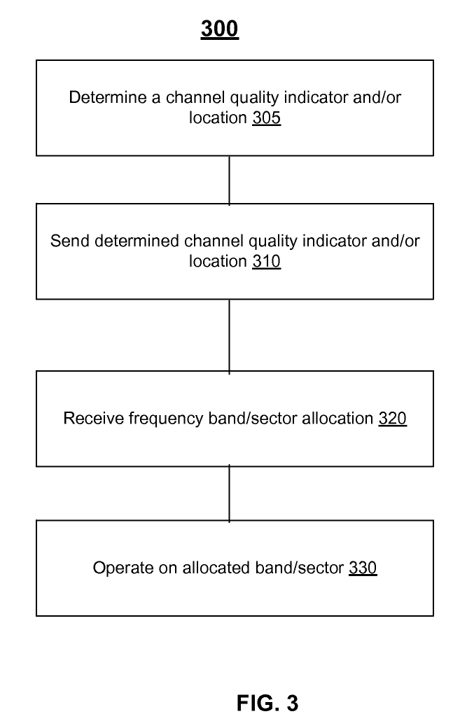

FIG. 3 depicts an example of a process 300 for allocating resources including allocating an antenna sector to a client device, such as a CPE, in accordance with some example embodiments.

At 305, a channel quality indicator may be determined, in accordance with some example embodiments. For example, CPE 194A may measure an indication of the channel quality by for example determining SINR and/or other metrics for sector 114A as well as other sectors, such as sector 112C.

At 310, the determined channel quality indicator may be sent, in accordance with some example embodiments. For example, CPE 194A may send the measured channel quality indicator to resource allocator 290. The resource allocator 290 may then determine which sector satisfies a threshold channel quality, such as SINR, to CPE. And, the resource allocator 290 may allocate a sector based on the channel quality indicator information. For example, the resource allocator 290 may have a threshold SINR for a CPE in order to provide a given data rate to the CPE. If the channel quality indicator meets or exceeds the threshold SINR at a given sector, that sector can be assigned to the CPE. But if the channel quality indicator does not meets or exceed the threshold SINR at the given sector, that sector should not be assigned to the CPE (unless the threshold is revised or some other adjustment, such as a reallocation of the allocated CPEs, is performed). In some example embodiments, resource allocator 290 may take into account the modulation and coding scheme at CPE 194A and the received channel quality indicator, when determining which sector to allocate to the CPE. Moreover, the resource allocator may take into account the received channel quality indicator (as well as modulation and coding scheme, load at a given sector, and/or the like) received from a plurality of CPEs, when determining which sector to allocate to the CPE 194A (as well as other CPEs). Furthermore, the resource allocator may reallocate resources among CPEs to optimize channel quality among the CPEs.

The allocation of a sector noted above may be based on location information. If the location of the base station and CPE are known (as well as the sector pattern), then the sector to be allocated to the CPE may also be performed based on location alone (or in combination with the channel quality indicator). For example, the CPE may report its location to the base station, which may then assign a sector for downlink transmission based on the location of the CPE and the corresponding sectors covering the location of the CPE. Alternatively or additionally, the CPE may determine the base station location (for example, the location may be determined or reported to the CPE), and form a beam, such as beam 198, to enable transmission of an uplink to the base station.

At 320, a resource, such as a frequency and sector allocation, may be received, in accordance with some example embodiments. For example, resource allocator 290 may determine which sector to assign as noted above, and send the allocated sector and band to CPE 194A. The allocation may include other information as well, such as modulation, coding, and/or the like. When the CPE receives the allocation, CPE 194A can operate on the allocated sector, such as sector 114A for example.

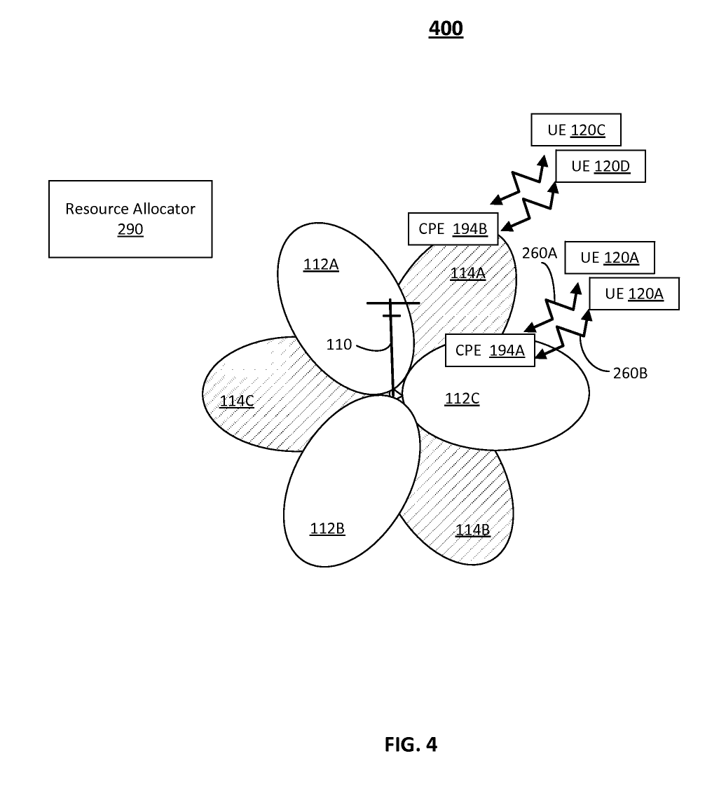

FIG. 4 depicts an example of a system 400, in accordance with some example embodiments. System 400 is similar to system 200 in some respects, but depicts the introduction of a CPE 194B at sector 114A. When this is the case, the network may trigger process 300 in order to allocate resources to CPE 194B, which may also result in a reallocation to CPE 194A as well. For example, the CPEs in the site served by base station 110 may receive their resource allocation. This resource allocation may be dynamic in the sense that it may change from time to time, such as after the introduction of another CPE, the departure of a CPE, changing conditions in the network, such as load, and/or other reasons as well.

In the example of FIG. 4, when CPE 194B enters the site 400, process 300 may be triggered and result in band one sector 114A being allocated to CPE 194B for example. Resource allocator 190 may also allocate (or reallocate) resources to the other CPEs. Specifically, resource allocator may take into account the load on each sector, in accordance with some example embodiments. For example, CPE 194A-B may both be allocated to sector 114A on band one, but the resource allocator may as part of process 300 subsequently reallocate CPE 194A to sector 112C if sector 114A is overly burdened with a heavy traffic load (or for some other reason such as a beneficial SNIR in another sector, or to optimize the overall network capacity where all of the sites are taken into account), while sector 112C is lightly loaded. Thus, in some example, embodiments, the resource allocator may perform load balancing by allocating sectors 112A-C/114A-C.

Although the example above describes the resource allocation being performed by the network, a client device, such as CPE and/or any other device may perform the allocation as well. Further, the resource allocation may be performed dynamically such that optimum total capacity across CPE and sectors is determined at any given moment.

### Example Use Case

In some example embodiments, the CPE, such as CPE 194A, 194B, and/or the like (FIG. 4), may be used in a LTTH implementations. During the initial power-up and installation of for example CPE 194A, the location of CPE 194 may be sent via a wired or wireless link to resource allocator 290. In response, the resource allocator may identify which site, such as which base station from among a plurality of base stations, and which sector, from among sectors 114A-C and 112A-C, should be assigned to CPE 114A. The resource allocator 290 may also calculate the direction from the CPE 194A to the selected site (for example, base station 110) to enable CPE 194 to beam steer to the base station 110. The resource allocator may provide the determined site, sector, and/or direction to CPE 194A (via wireless and/or wired links). The direction to the site/base station may be used by the end-user to place the CPE 194A (or its antenna(s)) on for example on a side of the home/premises as the direction to the site/base station. The CPE 194A may then beam form or steer its directional antenna towards the direction of the site and/base station, and then transmit and/or receive on the assigned site and sector (and mapped frequency).

In some example embodiments, carrier aggregation may be implemented as well. Referring again to FIG. 1A, CPE 194A having access to carriers from sector 114A and sector 112C may enter into a carrier aggregation mode (for example, in which the carrier from sector 114A is a primary carrier and the carrier from sector 112C is the secondary carrier). To illustrate, the CPE 194A may perform measurements of the carriers associated with sectors 114A and 112C, and if the measurements satisfy a quality threshold (for example, an SINR threshold or target), the CPE 194A may enter into the carrier aggregation mode. However, if CPE 194 is in a location covered by only a single sector (and/or the quality thresholds are not satisfied), the CPE may decide to not enter into a carrier aggregation mode.

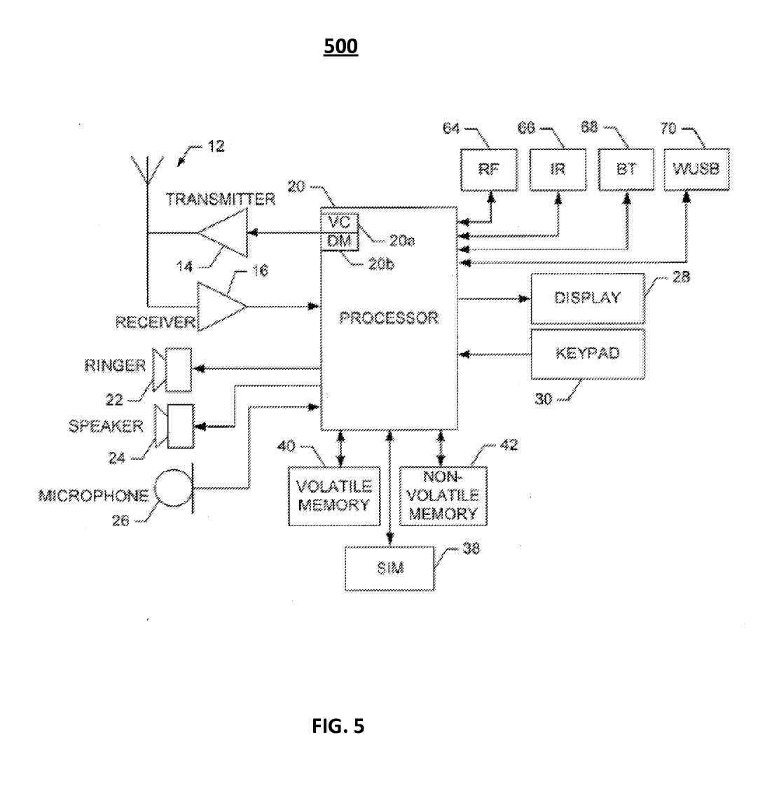

FIG. 5 depicts an example of an apparatus 500, in accordance with some example embodiments. The apparatus 500 may comprise a CPE as described herein and/or a user equipment (UE), such as a smart phone, a tablet, a cell phone, a wearable radio device, and/or any other radio based device including for example a wireless access point/base station. Moreover, the resource allocator 290 may comprise circuitry as described with respect to apparatus 500, although the resource allocator 290 may be implemented with a wired interface to other devices (rather than the wireless interfaces shown at FIG. 5) as well. The resource allocator 290 may be provided as a service, such as a cloud/internet service accessible to the network, base station, CPEs, and/or other devices.

The CPE may serve, in some example embodiments, as a router or gateway to other devices at the customer premises, and these other devices may include a smart phone, a tablet, a laptop with a wireless interface, a cell phone, a wearable radio device, an internet of things (IoT) device (for example, in which case the CPE may provide an IoT gateway), audio players (for example, audio player including a wireless interface to enable audio streaming), televisions (for example, smart televisions including a wireless interface to enable streaming) and/or any other radio based device. The apparatus may include a first interface to the cellular network and a second interface (which may wired and/or wireless) to the other devices.

In some example embodiments, apparatus 500 may also include a radio communication link to a cellular network, or other wireless network. The apparatus 500 may include at least one antenna 12 in communication with a transmitter 14 and a receiver 16. Moreover, the antenna may be a sector antenna and/or a plurality of antennas though which beamforming (for example, MIMO and/or the like) that can provide a given sector. Alternatively transmit and receive antennas may be separate.

The apparatus 500 may also include a processor 20 configured to provide signals to and from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 130 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 500 may include a location processor and/or an interface to obtain location information, such as positioning and/or navigation information. Accordingly, although illustrated in as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as, Institute of Electrical and Electronics Engineers (IEEE) 802.11, 802.16, and/or the like. In addition, these signals may include speech data, user generated data, user requested data, and/or the like.

The apparatus 500 may be capable of operating with one or more air interface standards, communication protocols, modulation types, access types, and/or the like. For example, the apparatus 500 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 500 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 500 may be capable of operating in accordance with 2.5G wireless communication protocols General Packet Radio Service (GPRS), Enhanced Data GSM Environment (EDGE), and/or the like. Further, for example, the apparatus 500 may be capable of operating in accordance with 3G wireless communication protocols, such as, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 130 may be additionally capable of operating in accordance with 3.9G wireless communication protocols, such as, Long Term Evolution (LTE), Evolved Universal Terrestrial Radio Access Network (E-UTRAN), and/or the like. Additionally, for example, the apparatus 500 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 500. For example, the processor 20 may comprise a digital signal processor device, a microprocessor device, an analog-to-digital converter, a digital-to-analog converter, and/or the like. Control and signal processing functions of the apparatus 500 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 500 to perform actions. For example, processor 20 may be capable of operating a connectivity program, such as, a web browser. The connectivity program may allow the apparatus 500 to transmit and receive web content, such as location-based content, according to a protocol, such as, wireless application protocol, wireless access point, hypertext transfer protocol, HTTP, and/or the like.

Apparatus 500 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 500 may include a battery for powering various circuits related to the mobile terminal, for example, a circuit to provide mechanical vibration as a detectable output. The user input interface may comprise devices allowing the apparatus 500 to receive data, such as, a keypad 30 and/or other input devices. Moreover, apparatus may provide an LTTH application or an LTTH service where configuration and/or control of the CPE may be performed.

Moreover, the apparatus 500 may include a short-range radio frequency (RF) transceiver and/or interrogator 64, so data may be shared with and/or obtained from electronic devices in accordance with RF techniques. The apparatus 500 may include other short-range transceivers, such as an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, Bluetooth Low-Energy, NFC, and other radio standards. In this regard, the apparatus 500 and, in particular, the short-range transceiver may be capable of transmitting data to and/or receiving data from electronic devices within proximity of the apparatus, such as within 10 meters. The apparatus 500 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 500 may comprise memory, such as, a subscriber identity module (SIM) 38, a removable user identity module (R-UIM), and/or the like, which may store information elements related to a mobile subscriber. In addition to the SIM, the apparatus 500 may include other removable and/or fixed memory. The apparatus 500 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations as described herein at for example process 300. The memories may comprise an identifier, such as an international mobile equipment identification (IMEI) code, capable of uniquely identifying apparatus 500. The functions may include one or more of the operations disclosed herein with respect to process 300 and/or the like. The memories may comprise an identifier, such as an international mobile equipment identification (IMEI) code, capable of uniquely identifying apparatus 500. In the example embodiment, the processor 20 may be configured using computer code stored at memory 40 and/or 42 to provide the operations, such as receiving, at a user equipment, an allocation of an antenna sector and a frequency band, wherein the allocation is selected from a plurality of sectors, wherein adjacent sectors in the plurality of sectors operate at different frequencies and intersect at about a midpoint to enable a reduction in interference among the adjacent sectors; and operating, at the user equipment, on the allocated antenna sector by at least one of transmitting or receiving on the allocated antenna sector and frequency band.

Some of the embodiments disclosed herein may be implemented in software, hardware, application logic, or a combination of software, hardware, and application logic. The software, application logic, and/or hardware may reside in memory 40, the control apparatus 20, or electronic components disclosed herein, for example. In some example embodiments, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry. A computer-readable medium may comprise a non-transitory computer-readable storage medium that may be any media that can contain or store the instructions for use by or in connection with an instruction execution system, apparatus, or device, such as a computer. Furthermore, some of the embodiments disclosed herein include computer programs configured to cause methods as disclosed herein (see, for example, the process 300 and the like).

Without in any way limiting the scope, interpretation, or application of the claims appearing below, a technical effect of one or more of the example embodiments disclosed herein is reduced intra site sector interference and/or reduce interference from multiple CPEs.

The subject matter described herein may be embodied in systems, apparatus, methods, and/or articles depending on the desired configuration. For example, the systems, apparatus, methods, and/or articles described herein can be implemented using one or more of the following: electronic components such as transistors, inductors, capacitors, resistors, and the like, a processor executing program code, an application-specific integrated circuit (ASIC), a digital signal processor (DSP), an embedded processor, a field programmable gate array (FPGA), and/or combinations thereof. These various example embodiments may include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-48. (canceled)

49. A method comprising:
receiving an allocation of an antenna sector and a frequency band, wherein the allocation is selected from a plurality of sectors, wherein adjacent sectors in the plurality of sectors operate at different frequencies and intersect at a midpoint to enable a reduction in interference among the adjacent sectors; and
receiving and/or transmitting, in response to the received allocation, on the allocated antenna sector and frequency band.

50. The method of claim 49, wherein the adjacent sectors include the allocated antenna sector and the allocated frequency band and another antenna sector and another frequency band, wherein the allocated frequency band and the other frequency band operate at different cellular frequencies, and wherein the allocated antenna sector and the other antenna sector intersect at the midpoint comprising 30 degrees.

51. The method of claim 50, wherein the allocated antenna sector and the other antenna sector are spaced by 60 degrees.

52. The method of claim 50, wherein a base station includes an antenna array having a sector pattern including the allocated antenna sector and the other antenna sector spaced by 60 degrees from the allocated antenna sector.

53. The method of claim 52, wherein the sector pattern includes six sectors spaced at 60 degrees between each sector, wherein any of the adjacent sectors operate at different frequencies.

54. The method of claim 49, wherein the plurality of sectors form a sector pattern including 12 sectors spaced by 30 degrees.

55. The method of claim 49, wherein the receiving and/or transmitting is performed in a carrier aggregation in which first and second carriers from the adjacent sectors are used for the carrier aggregation.

56. An apparatus, comprising:
at least one processor; and
at least one memory including computer program code, the at least one memory and the computer program code configured to, with the at least one processor, cause the apparatus to perform at least the following:
receive an allocation of an antenna sector and a frequency band, wherein the allocation is selected from a plurality of sectors, wherein adjacent sectors in the plurality of sectors operate at different frequencies and intersect at a midpoint to enable a reduction in interference among the adjacent sectors; and
receive and/or transmit, in response to the received allocation, on the allocated antenna sector and frequency band.

57. The apparatus of claim 56, wherein the adjacent sectors include the allocated antenna sector and the allocated frequency band and another antenna sector and another frequency band, wherein the allocated frequency band and the other frequency band operate at different cellular frequencies, and wherein the allocated antenna sector and the other antenna sector intersect at the midpoint comprising 30 degrees.

58. The apparatus of claim 57, wherein the allocated antenna sector and the other antenna sector are spaced by 60 degrees.

59. The apparatus of claim 57, wherein a base station includes an antenna array having a sector pattern including the allocated antenna sector and the other antenna sector spaced by 60 degrees from the allocated antenna sector.

60. The apparatus of claim 59, wherein the sector pattern includes six sectors spaced at 60 degrees between each sector, wherein any of the adjacent sectors operate at different frequencies.

61. The apparatus of claim 59, wherein the sector pattern is fixed at a given base station.

62. The apparatus of claim 56 the apparatus is further caused to send at least one channel quality indicator to a network to enable resource allocation, wherein the at least one channel quality indicator includes a measurement of a channel on the antenna sector and the frequency band.

63. The apparatus of claim 56, wherein the apparatus is further caused to send a location of the apparatus to a network to enable a response including a resource allocation.

64. The apparatus of claim 56, wherein the apparatus is further caused to at least determine a base station location to enable formation of a beam in a direction covering the base station.

65. The apparatus of claim 56, wherein the apparatus comprises at least one of a user equipment or a customer premises equipment, wherein the customer premises equipment includes a first interface for interfacing with a cellular network and a second interface for interfacing with at least one other apparatus within a customer premises.

66. The apparatus of claim 56, wherein the plurality of sectors form a sector pattern including 12 sectors spaced by 30 degrees.

67. The apparatus of claim 56, wherein the apparatus is further caused to receive and/or transmit in a carrier aggregation in which first and second carriers from the adjacent sectors are used for the carrier aggregation.

68. An apparatus, comprising:
at least one processor; and
at least one memory including computer program code, the at least one memory and the computer program code configured to, with the at least one processor, cause the apparatus to perform at least the following:
receive, at the apparatus, information comprising at least one of a channel quality indicator measured by a user equipment or a location of the user equipment; and
send, by the apparatus, an allocation to the user equipment, wherein the allocation includes an antenna sector and a frequency band, wherein the allocation is based on the received information, wherein the allocation is selected from a plurality of sectors, wherein adjacent sectors in the plurality of sectors operate at different frequencies and intersect at a midpoint to enable a reduction in interference among the adjacent sectors.
